(19) United States
(12) Patent Application Publication
(10) Pub. No.: US 2025/0301057 A1
(43) Pub. Date: Sep. 25, 2025

(54) SETTING AND/OR DETECTING INTERNET PROTOCOL VERSION OF O-RU IN O-RAN

(71) Applicant: RAKUTEN MOBILE, INC., Tokyo (JP)

(72) Inventors: Awn MUHAMMAD, Tokyo (JP); Pankaj SHETE, Tokyo (JP)

(73) Assignee: RAKUTEN MOBILE, INC., Tokyo (JP)

(21) Appl. No.: 18/283,920

(22) PCT Filed: Apr. 14, 2022
(86) PCT No.: PCT/JP2022/017799

§ 371 Date: Apr. 8, 2024

(30) Foreign Application Priority Data
Jan. 18, 2022 (WO) PCT/JP2022/001559

(51) Int. Cl. H04L 69/167; H04L 67/142; H04W 52/02

(52) U.S. Cl. CPC H04L 69/167; H04L 67/142; H04W 52/0206

(57) ABSTRACT

A radio access network control apparatus for controlling an O-RAN including the O-RU as a radio unit has at least one processor that performs: by an IP version setting unit, setting the Internet Protocol version required for the O-RU to IPv6; by an IP version detecting unit capable of communicating with the O-RU, detecting that IPv6 is included in the Internet Protocol version supported by the O-RU. The IP version detecting unit functions as a NETCONF client in the NETCONF implemented via the O1 interface, and acquires from the O-RU that functions as a NETCONF server the information suggesting the Internet Protocol version supported by the O-RU.

### TECHNICAL FIELD

The present disclosure relates to setting and/or detecting the Internet Protocol version of an O-RU in an O-RAN.

### BACKGROUND ART

For the purpose of the so-called open radio access network (RAN) in a mobile communication system, “Open RAN”, “O-RAN”, “VRAN” etc. are being considered. In this specification, “O-RAN” is used as a comprehensive term for such various “open radio access networks”. Therefore, the interpretation of “O-RAN” in this specification is not limited to the standard and/or the specification of the same name “O-RAN” specified by the O-RAN Alliance.

A radio unit (RU) in the O-RAN is called an O-RU and provides a communication cell to a communication device (UE: User Equipment). An O-RU is controlled by a RAN node composed by an O-CU, which is a central unit (CU), and/or an O-DU, which is distributed unit (DU). Furthermore, a RAN node is controlled by a higher-level controller such as a Near-RT RIC (Near-Real Time RAN Intelligent Controller) and/or a Non-RT RIC (Non-Real Time RAN Intelligent Controller). In the O-RAN, a virtual infrastructure also referred to as O-Cloud that virtually manages a set of a plurality of RAN nodes is also provided.

### RELATED-ART LITERATURE

### Patent Literature

Patent Literature 1: JP-A-2021-83058

### SUMMARY OF INVENTION

### Technical Problem

In the conventional O-RAN, all O-RUs have been required to support the IPv4 of the Internet Protocol version. However, some telecommunication carriers that operate O-RANS (hereinafter also referred to as operators or carriers) may not use IPv4, resulting in the IPv4 functionality implemented in O-RUs in vain.

The present disclosure was made in view of these circumstances, and its purpose is to provide a radio access network control apparatus and the like that can alleviate the restrictions about the Internet Protocol version of the O-RU.

### Solution to Problem

In order to solve the above problem, a radio access network control apparatus in a certain aspect of the present disclosure for controlling an O-RAN including the O-RU as a radio unit comprises at least one processor that performs: by an IP version setting unit, setting the Internet Protocol version required for the O-RU to IPv6.

According to this aspect, the Internet Protocol version of the O-RU can be set to IPv6, thereby alleviating the conventional restrictions about the Internet Protocol version of the O-RU.

Another aspect of the present disclosure is also a radio access network control apparatus for controlling an O-RAN including the O-RU as a radio unit. The apparatus comprises at least one processor that performs: by an IP version detecting unit capable of communicating with the O-RU, detecting that IPv6 is included in the Internet Protocol version supported by the O-RU.

According to this aspect, it is possible to detect that IPv6 is included in the Internet Protocol version supported by the O-RU, thereby alleviating the conventional restrictions about the Internet Protocol version of the O-RU.

Further another aspect of the present disclosure is a radio access network control method for controlling an O-RAN including the O-RU as a radio unit. The method comprises: setting the Internet Protocol version required for the O-RU to IPv6.

Further another aspect of the present disclosure is also a radio access network control method for controlling an O-RAN including the O-RU as a radio unit. The method comprises: by communicating with the O-RU, detecting that IPv6 is included in the Internet Protocol version supported by the O-RU.

Further another aspect of the present disclosure is a computer-readable medium. The computer-readable medium stores a radio access network control program for controlling an O-RAN including the O-RU as a radio unit causing a computer to perform: setting the Internet Protocol version required for the O-RU to IPv6.

Further another aspect of the present disclosure is a computer-readable medium. The computer-readable medium stores a radio access network control program for controlling an O-RAN including the O-RU as a radio unit causing a computer to perform: by communicating with the O-RU, detecting that IPv6 is included in the Internet Protocol version supported by the O-RU.

In addition, any combination of the above components, and any conversion of the expression of the present disclosure among methods, devices, systems, recording media, computer programs and the like are also encompassed within this disclosure.

### Advantageous Effects of Invention

According to the present disclosure, the restrictions about the Internet Protocol version of the O-RU can be alleviated.

### BRIEF DESCRIPTION OF DRAWINGS

FIG. 1 is a schematic overview of a radio access network control apparatus.

FIG. 2 schematically shows various functions realized in the SMO and/or the Non-RT RIC and O-Cloud.

FIG. 3 is a functional block diagram schematically showing the radio access network control apparatus.

### DESCRIPTION OF EMBODIMENTS

In the following, the present embodiment is described in accordance with the “O-RAN” which is the standard and/or the specification developed by the O-RAN Alliance. Therefore, the known terms defined in “O-RAN” will be used in the present embodiment just for convenience, but the technologies according to this disclosure can be applied to other existing radio access networks such as “Open RAN” and “VRAN” and/or to similar radio access networks that may be developed in the future.

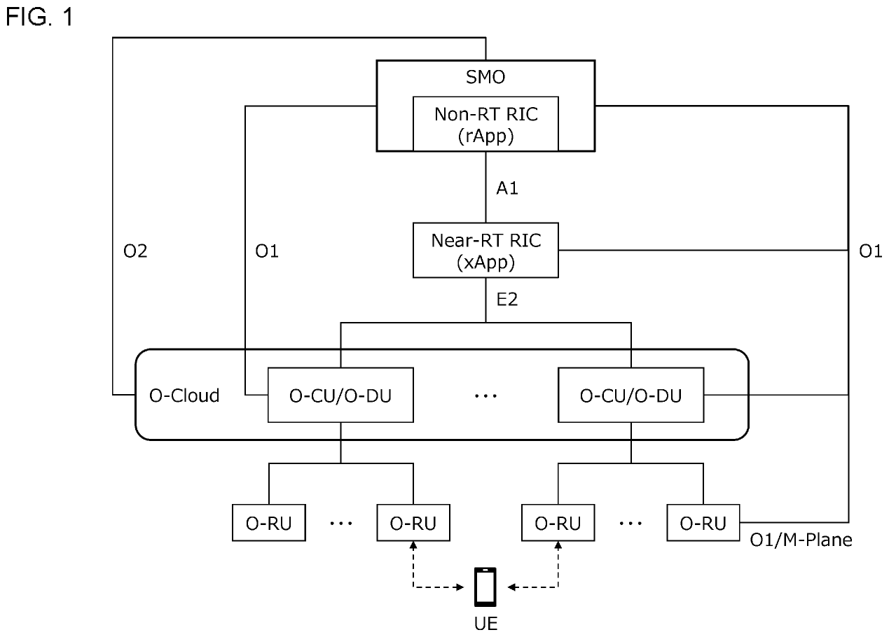

FIG. 1 shows a schematic overview of the radio access network control apparatus according to the present embodiment. This radio access network control apparatus is a RAN control apparatus that controls radio access network in accordance with an O-RAN. The SMO (Service Management and Orchestration) controls the entire RAN control apparatus or the entire O-RAN and coordinates the operations of each portion. The SMO is equipped with a Non-RT RIC (Non-Real Time RAN Intelligent Controller) that functions as the overall control processor responsible for overall control. The Non-RT RIC, which has a relatively long control cycle (e.g. 1 second or longer), issues guidelines, policies, guidance etc. concerning the operation of each RAN node (O-CU and/or O-DU as described below). Specifically, the Non-RT RIC executes application software called rApp to issue operational policy for each RAN node to the Near-RT RIC (Near-Real Time RAN Intelligent Controller) through the A1 interface. The Near-RT RIC, which has a relatively short control cycle (e.g. shorter than 1 second), executes application software called xApp to control each RAN node (O-CU/O-DU) itself and/or general-purpose hardware etc. in the radio unit (O-RU) connected to each of the RAN nodes through the E2 interface.

The illustrated RAN node has an O-CU, which is an O-RAN compliant central unit (CU), and/or O-DU, which is an O-RAN compliant distributed unit (DU). Both of the O-CU and the O-DU are responsible for baseband processing in the O-RAN, where the O-CU is provided on the side of the core network (not shown in the figure), and the O-DU is provided on the side of the O-RU, which is an O-RAN compliant radio unit (RU). The O-CU may be divided into the O-CU-CP, which constitutes the control plane (CP), and the O-CU-UP, which constitutes the user plane (UP). The O-CU and the O-DU may be integrally configured as a single baseband processing unit. The O-eNB as a base station compliant with the O-RAN and the 4th generation mobile communication system (4G), may be provided as a RAN node. One or more O-RUs are connected to each RAN node (O-CU/O-DU) and are controlled by the Near-RT RIC via each of the RAN nodes. A communication device (UE: User Equipment) in the communication cell provided by each O-RU can be connected to each of the O-RUs, and can perform mobile communication with the core network (not shown) via each RAN node (O-CU/O-DU).

Each RAN node (O-CU/O-DU) and the Near-RT RIC provide operational data etc. of each RAN node, each O-RU and each UE through the O1 interface to the SMO for so-called FCAPS (Fault, Configuration, Accounting, Performance, Security). The SMO updates as necessary the operational policy for each RAN node issued by the Non-RT RIC to the Near-RT RIC through the A1 interface, based on the operational data acquired through the O1 interface. The O-RUs may be connected to the SMO for the FCAPS by the O1 interface and/or other interfaces (e.g. Open Fronthaul M-Plane).

The O-Cloud as a virtual infrastructure that virtually manages a set of the plurality of RAN nodes (O-CUs/O-DUs) is connected to the SMO by an O2 interface. The SMO generates a resource allocation policy concerning the resource allocation and/or a workload management policy concerning the workload management of the plurality of RAN nodes, based on the operational states of the plurality of RAN nodes (O-CUs/O-DUs) acquired from the O-Cloud through the O2 interface, and issues them to the O-Cloud through the O2 interface.

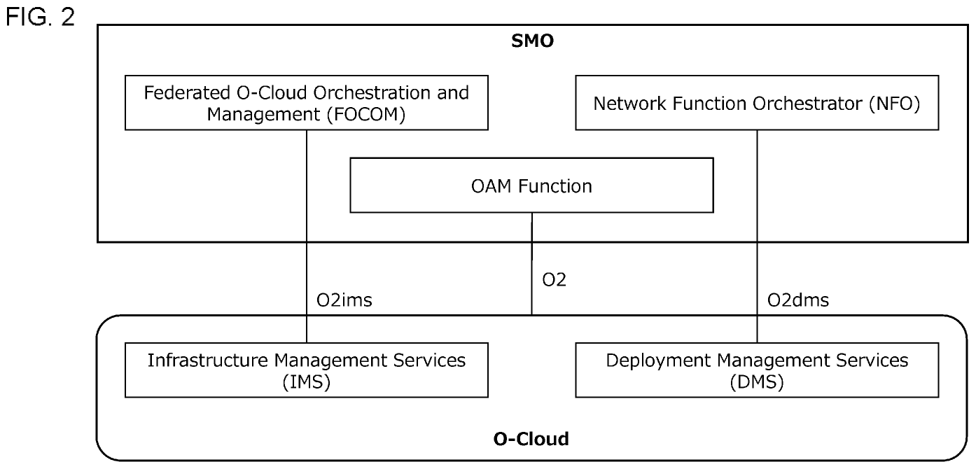

FIG. 2 schematically shows the various functions realized in the SMO and/or the Non-RT RIC and the O-Cloud. In the SMO, three main functions are realized, which are the FOCOM (Federated O-Cloud Orchestration and Management), the NFO (Network Function Orchestrator) and the OAM Function. In the O-Cloud, two main functions are realized, which are the IMS (Infrastructure Management Services) and the DMS (Deployment Management Services).

The FOCOM manages resources in the O-Cloud, while receiving services from the IMS of the O-Cloud through the O2 interface (O2ims). The NFO realizes the orchestrated operation of a set of network functions (NFs) by a plurality of NF Deployments in the O-Cloud, while receiving services from the DMS of the O-Cloud through the O2 interface (O2dms). The NFO may utilize the OAM Function to access the deployed NFs through the O1 interface. The OAM Function is responsible for the FCAPS management of O-RAN managed entities such as the RAN nodes. The OAM Function in the present embodiment can be a functional block where callbacks are provided for receiving data concerning failures and/or operational states of the plurality of RAN nodes that are virtually managed by the O-Cloud, by monitoring processes or procedures over the O2ims and/or the O2dms. The IMS is responsible for managing the O-Cloud resources (hardware) and/or the software used for managing them, and provides services primarily to the FOCOM of the SMO. The DMS is responsible for the management of the plurality of NF Deployments in the O-Cloud, specifically the initiation, monitoring, termination etc., and provides services primarily to the NFO of the SMO.

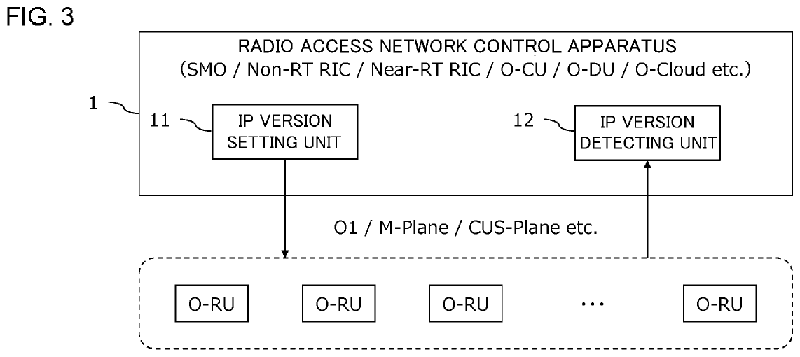

FIG. 3 is a functional block diagram schematically showing the radio access network control apparatus 1 according to the present embodiment. The radio access network control apparatus 1 comprises an IP version setting unit 11 and an IP version detecting unit 12. These functional blocks are realized by the cooperation of hardware resources, such as the central processing unit, memory, input devices, output devices, and peripheral devices connected to the computer, and software that is executed using them. Regardless of the type of computer or its installation location, each of the above functional blocks may be realized with the hardware resources of a single computer, or by combining hardware resources distributed across plurality of computers. Especially in the present embodiment, some or all of the functional blocks of the radio access network control apparatus 1 may be realized in a computer and/or a processor provided in any part of the O-RAN (except for the O-RU) such as the SMO, the Non-RT RIC, the Near-RT RIC, the RAN node composed by the O-CU and/or the O-DU, and the O-Cloud in a distributed manner or a centralized manner, or may be realized in a computer and/or a processor provided outside the O-RAN and capable of communicating with the O-RAN in a distributed manner or a centralized manner. It should be noted that at least one of the IP version setting unit 11 and the IP version detecting unit 12 may be provided.

The radio access network control apparatus 1 (the IP version setting unit 11 and/or the IP version detection unit 12) that controls the O-RAN including the O-RU as a radio unit, are capable of communicating in at least one direction via at least one interface with one or more O-RUs that are the main control targets. For example, as also schematically shown in FIG. 1, the O-RU can communicate bidirectionally or unidirectionally with the RAN node (O-CU and/or O-DU), the Near-RT RIC, the SMO (including the Non-RT RIC) etc. that can constitute the radio access network control apparatus 1, via the O1 interface, the Open Fronthaul M-Plane etc. The O-RU can also communicate bidirectionally or unidirectionally with the RAN node (O-CU and/or O-DU) etc. that can constitute the radio access network control apparatus 1, via the Open Fronthaul CUS-Plane etc.

The IP version setting unit 11, which can communicate with the O-RU, is capable of setting the Internet Protocol version required for each O-RU to IPv6. The IP version setting unit 11 is also capable of setting the Internet Protocol version required for each O-RU to IPv4. Furthermore, the IP version setting unit 11 is also capable of setting the Internet Protocol version required for each 0-RU to both IPv4 and IPv6. In other words, the IP version setting unit 11 is capable of setting the Internet Protocol version required for each O-RU to at least three patterns “IPv4”, “IPv6” and “both IPv4 and IPv6”. It should be noted that the expressions “IPv4”, “IPv6” and “both IPv4 and IPv6” focus only on IPv4 and/or IPv6. Therefore, they may include Internet Protocol versions other than IPv4 and IPv6.

The IP version detecting unit 12, which can communicate with the O-RU, is capable of detecting that IPv6 is included in the Internet Protocol version supported by each O-RU. The IP version detecting unit 12 is also capable of detecting that IPv4 is included in the Internet Protocol version supported by each O-RU. Furthermore, the IP version detecting unit 12 is also capable of detecting that both IPv4 and IPv6 are included in the Internet Protocol version supported by each O-RU. In other words, the IP version detecting unit 12 is capable of detecting that the Internet Protocol version supported by each O-RU is one of the at least three patterns “IPv4”, “IPv6” and “both IPv4 and IPv6”. It should be noted that the expressions “IPv4”, “IPv6” and “both IPv4 and IPv6” focus only on IPv4 and/or IPv6. Therefore, they may include Internet Protocol versions other than IPv4 and IPv6.

For example, the IP version detecting unit 12 can acquire the information suggesting the Internet Protocol version supported by each O-RU, directly or indirectly from each of such O-RUs, using the NETCONF or other network configuration protocols implemented via the O1 interface etc. In the NETCONF implemented via the O1 interface, the SMO functions as a NETCONF client and the O-RU (and/or the Near-RT RIC, the O-CU, the O-DU) functions as a NETCONF server. The SMO etc. as the NETCONF client may generate a list of interfaces supported by each O-RU as the NETCONF server through the RPC (Remote Procedure Call) constituting the NETCONF, and may estimate that, from the fact that an IPv4 container and/or an IPv6 container is present in the O-RAN interface module.

In the conventional O-RAN, all O-RUs have been required to support the IPv4 of the Internet Protocol version. However, some telecommunication carriers that operate O-RANS may not use IPv4, resulting in the IPv4 functionality implemented in O-RUs in vain. According to the present embodiment, the Internet Protocol version of the O-RU can be set to IPv6, thereby alleviating the conventional restrictions about the Internet Protocol version of the O-RU. In addition, according to the present embodiment, it is possible to detect that IPv6 is included in the Internet Protocol version supported by the O-RU, thereby alleviating the conventional restrictions about the Internet Protocol version of the O-RU.

The present disclosure has been described above based on embodiments. It is obvious to those skilled in the art that various variations are possible in the combination of each component and/or each process in the exemplary embodiments, and that such variations are also encompassed within the scope of the present disclosure.

It should be noted that the structures, the operations, and the functions of each apparatus and/or each method described in the embodiments can be realized by hardware resources or software resources, or by the cooperation of hardware resources and software resources. As hardware resources, for example, processors, ROMS, RAMs and various integrated circuits can be used. As software resources, for example, programs such as operating systems and applications can be used.

The present disclosure may be expressed as the following items.

Item 1: A radio access network control apparatus for controlling an O-RAN including the O-RU as a radio unit comprising at least one processor that performs:
by an IP version setting unit, setting the Internet Protocol version required for the O-RU to IPv6.
   Item 2: The radio access network control apparatus according to item 1, wherein the IP version setting unit is capable of setting the Internet Protocol version required for the O-RU to IPv4.
   Item 3: The radio access network control apparatus according to item 1 or 2, wherein the IP version setting unit is capable of setting the Internet Protocol version required for the O-RU to both IPv4 and IPv6.
   Item 4: The radio access network control apparatus according to any of items 1 to 3, wherein the IP version setting unit is capable of setting the Internet Protocol version required for the O-RU to either IPv4, IPv6, or both IPv4 and IPv6.
   Item 5: A radio access network control apparatus for controlling an O-RAN including the O-RU as a radio unit comprising at least one processor that performs:
by an IP version detecting unit capable of communicating with the O-RU, detecting that IPv6 is included in the Internet Protocol version supported by the O-RU.
   Item 6: The radio access network control apparatus according to item 5, wherein the IP version detecting unit is capable of detecting that IPv4 is included in the Internet Protocol version supported by the O-RU.
   Item 7: The radio access network control apparatus according to item 5 or 6, wherein the IP version detecting unit is capable of detecting that both IPv4 and IPv6 are included in the Internet Protocol version supported by the O-RU.
   Item 8: The radio access network control apparatus according to any of items 5 to 7, wherein the IP version detecting unit is capable of detecting that either IPv4, IPv6, or both IPv4 and IPv6 is included in the Internet Protocol version supported by the O-RU.
   Item 9: The radio access network control apparatus according to any of items 5 to 8, wherein the IP version detecting unit functions as a NETCONF client in the NETCONF implemented via the O1 interface, and acquires from the O-RU that functions as a NETCONF server the information suggesting the Internet Protocol version supported by the O-RU.
   Item 10: A radio access network control method for controlling an O-RAN including the O-RU as a radio unit comprising:
setting the Internet Protocol version required for the O-RU to IPv6.
   Item 11: A radio access network control method for controlling an O-RAN including the O-RU as a radio unit comprising:
by communicating with the O-RU, detecting that IPv6 is included in the Internet Protocol version supported by the O-RU.
   Item 12: A computer-readable medium storing a radio access network control program for controlling an O-RAN including the O-RU as a radio unit causing a computer to perform: setting the Internet Protocol version required for the O-RU to IPv6.
   Item 13: A computer-readable medium storing a radio access network control program for controlling an O-RAN including the O-RU as a radio unit causing a computer to perform: by communicating with the O-RU, detecting that IPv6 is included in the Internet Protocol version supported by the O-RU.

This application claims priority based on international patent application PCT/JP2022/001559, filed on Jan. 18, 2022, which is hereby incorporated by reference in its entirety.

### INDUSTRIAL APPLICABILITY

The present disclosure relates to setting and/or detecting the Internet Protocol version of an O-RU in an O-RAN.

### REFERENCE SIGNS LIST

1 radio access network control apparatus, 11 IP version setting unit, 12 IP version detecting unit.

1. A radio access network control apparatus for controlling an O-RAN including the O-RU as a radio unit comprising at least one processor that performs:
by an IP version setting unit, setting the Internet Protocol version required for the O-RU to IPv6.

2. The radio access network control apparatus according to claim 1, wherein the IP version setting unit is capable of setting the Internet Protocol version required for the O-RU to IPv4.

3. The radio access network control apparatus according to claim 1, wherein the IP version setting unit is capable of setting the Internet Protocol version required for the O-RU to both IPv4 and IPv6.

4. The radio access network control apparatus according to claim 1, wherein the IP version setting unit is capable of setting the Internet Protocol version required for the O-RU to either IPv4, IPv6, or both IPv4 and IPv6.

5. A radio access network control apparatus for controlling an O-RAN including the O-RU as a radio unit comprising at least one processor that performs:
by an IP version detecting unit capable of communicating with the O-RU, detecting that IPv6 is included in the Internet Protocol version supported by the O-RU.

6. The radio access network control apparatus according to claim 5, wherein the IP version detecting unit is capable of detecting that IPv4 is included in the Internet Protocol version supported by the O-RU.

7. The radio access network control apparatus according to claim 5, wherein the IP version detecting unit is capable of detecting that both IPv4 and IPv6 are included in the Internet Protocol version supported by the O-RU.

8. The radio access network control apparatus according to claim 5, wherein the IP version detecting unit is capable of detecting that either IPv4, IPv6, or both IPv4 and IPv6 is included in the Internet Protocol version supported by the O-RU.

9. The radio access network control apparatus according to claim 5, wherein the IP version detecting unit functions as a NETCONF client in the NETCONF implemented via the O1 interface, and acquires from the O-RU that functions as a NETCONF server the information suggesting the Internet Protocol version supported by the O-RU.

10. A radio access network control method for controlling an O-RAN including the O-RU as a radio unit comprising:
setting the Internet Protocol version required for the O-RU to IPv6.

11. A radio access network control method for controlling an O-RAN including the O-RU as a radio unit comprising:
by communicating with the O-RU, detecting that IPv6 is included in the Internet Protocol version supported by the O-RU.

12. A computer-readable medium storing a radio access network control program for controlling an O-RAN including the O-RU as a radio unit causing a computer to perform:
setting the Internet Protocol version required for the O-RU to IPv6.

13. A computer-readable medium storing a radio access network control program for controlling an O-RAN including the O-RU as a radio unit causing a computer to perform:
by communicating with the O-RU, detecting that IPv6 is included in the Internet Protocol version supported by the O-RU.
